(19) United States
(12) Patent Application Publication
(10) Pub. No.: US 2018/0199544 A1
(43) Pub. Date: Jul. 19, 2018

(54) Horse Blanket with Insulative Insert

(71) Applicant: Noble Rider, LLC, Modesto, CA (US)

(72) Inventor: Chris Ellsworth, Modesto, CA (US)

(21) Appl. No.: 15/481,351

(22) Filed: Apr. 6, 2017

Related U.S. Application Data
(60) Provisional application No. 62/319,508, filed on Apr. 7, 2016.

(51) Int. Cl. A01K 13/00

(52) U.S. Cl. CPC A01K 13/008

(57) ABSTRACT

A horse blanket includes a blanket shell to protect a horse from cold and moisture, and when needed in colder weather, it can be augmented by insertion of one of several insulators into a space provided between layers of the blanket shell. The blanket shell's outer layer is waterproof and weather-resistant, with the inner layer that bears against the horse having a surface comfortable to the horse. The outer layer has one and preferably two elongated access openings, positioned to be at left and right sides of the horse, for inserting, removing or exchanging insulative inserts.

### BACKGROUND OF THE INVENTION

This application claims benefit of provisional application Ser. No. 62/319,508, filed Apr. 7, 2016.

This invention concerns horses, and particularly horse blankets worn to keep the horse dry and warm in cold or wet weather.

Horse blankets are often used to cover a horse in cold or inclement weather such as rain or snow. These blankets are typically made of waterproof material. Such a blanket, which covers the horse usually from the neck back to the tail, secured together by straps or connectors beneath the horse's torso, keeps the horse warm and mostly dry, providing important protection for lengthy periods of time out in the elements. Often, due to weather changes with warming or cooling of the air, the horse's blanket needs to be exchanged for one of greater or lesser warmth, i.e. insulative quality. This can be a difficult and time-consuming task, in that buckles must be detached at several locations beneath the horse, the entire mass of the blanket must be removed, and another blanket positioned on the horse and fastened underneath. All this may be required in very cold weather or in rain, snow or wind.

The following prior patents and patent documents have relevance to this invention: U.S. Pat. No. 5,802,823, U.S. Pub. No. 2014/0041599, and foreign patents Nos. CA 2484576, DE 102010035616, GB 2,406,492, GB 2,223,390 and RU 46921 U1.

Of the above documents, British published application No. 2,223,390 generally addresses the problem described above, that of adjusting the warmth of a horse blanket. The described device includes a two-layered blanket referred to as a bag, and a relatively heavy inner blanket for warmth, which is inserted through an opening into the bag. The access opening for insertion of the inner blanket, however, is either at one end of the blanket or the other, i.e. toward the horse's head or the horse's tail. The insertion, removal or changing of an inner blanket therefore tends to be inconvenient, difficult or perhaps dangerous. If the access is at the front of the two-layered outer blanket or bag, the attendant must gain access to the horse at the back of the neck, possibly using a ladder at one side of the horse or the other, making insertion of a warming blanket awkward and difficult. On the other hand, if access is gained from the rear, this will also be difficult in pushing the insert entirely into the bag, and there is a risk of being kicked by the horse.

### SUMMARY OF THE INVENTION

The invention provides a more efficient solution to the problems outlined above, with a horse blanket formed in two layers defining an interlayer space between. The blanket essentially is a shell formed of the two layers, the outer layer being waterproof and weather resistant, and the inner layer, against the horse, being one that is comfortable to the horse and can be similar to the under surface of prior horse blankets. Typically the shell can be a waterproof, breathable material in at least the outer layer, and can have a taffeta or mesh lining on the inner side of each layer, providing a relatively smooth surface.

The outer shell has an elongated slit opening in the outer layer that extends lengthwise relative to the horse, at one side of the horse or both. This opening can be closeable via a zipper, VELCRO or other convenient closure, in a way that maintains a water barrier. The slit opening gives access to the interlayer space between the two layers.

The blanket shell itself provides protection against the weather, including insulation and warmth for the horse. However, for colder or windier periods there may be a need for additional insulation for the horse's blanket. If the blanket is already being worn by the horse, with the blanket described herein, further insulation can be added easily and efficiently. An insulated insert, folded or otherwise in a compact form, is inserted through the opened slit into the interlayer space, then spread open or unfolded to essentially fill the space. The slit opening is then closed. The added insulation is provided without removing the blanket. If even further insulation is needed later, the blanket insert can be exchanged for another, heavier insert. Similarly, if weather conditions improve, an insert can easily and quickly be removed. Such changes can also be done using multiple insulative inserts that can be stacked within the space.

The insert is easily put in place and exchanged using the slit opening, which is on the side of the horse. Two access openings can be provided, one on each side, so that the attendant can use an opposing side to help in positioning the insert.

A primary object of the invention is to save time, inconvenience, exposure to the elements and discomfort to the horse when a horse blanket needs to be replaced with heavier insulation, with a replaceable insert arrangement that is conveniently used. These and other objects, advantages and features of the invention will be apparent from the following description of a preferred embodiment, considered along with the accompanying drawings.

### DESCRIPTION OF THE DRAWINGS

FIG. 1 is a side view showing a horse wearing a horse blanket of the invention.

FIG. 2 is a side view of the horse blanket shell alone.

FIG. 2A is a schematic cross section view.

FIG. 3 is a developed view of the horse blanket.

FIGS. 4 and 5 are bottom and top views of an insulator insert for the horse blanket.

FIG. 6 is a schematic plan view of the blanket shell shown flat.

### DESCRIPTION OF PREFERRED EMBODIMENTS

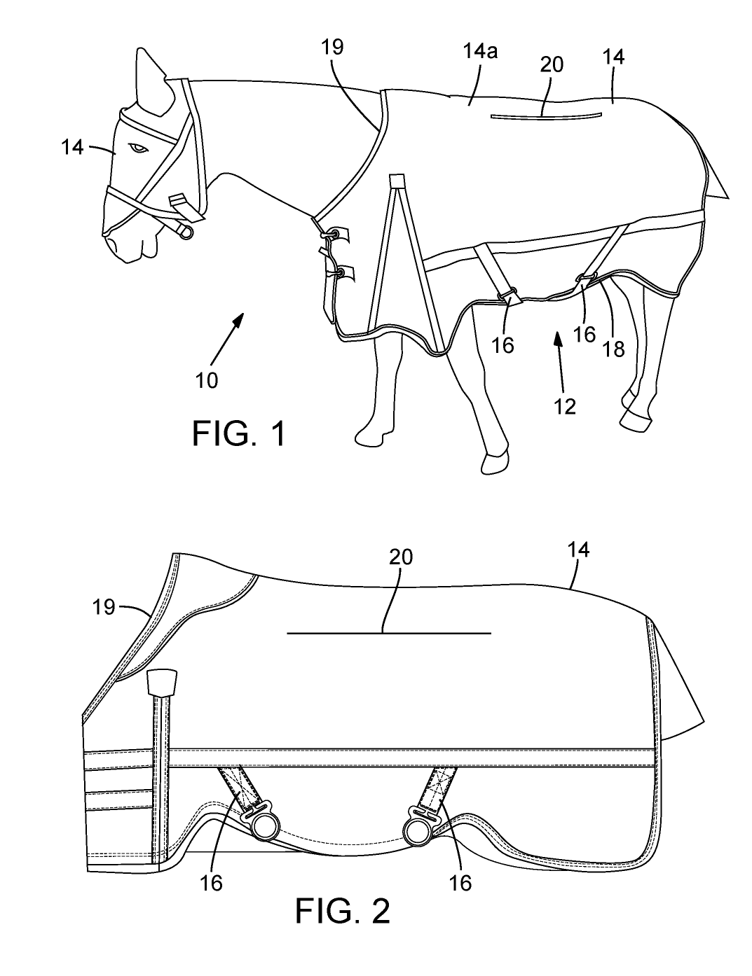

FIG. 1 shows a horse 10 wearing a horse blanket 12 of the invention. The blanket 12 comprises a blanket shell 14 which conforms comfortably to the horse and has connector straps 16 to connect lower ends 18 of the blanket beneath the horse, in the typical way. The front edge of the blanket is shown at 19. The blanket shell 14 includes two primary layers, the outer layer 14a being visible in FIG. 1; a proximate layer (proximate to the horse) is underneath, not visible in FIG. 1. In preferred embodiments either or both of the outer layer and the proximate or inner layer may be laminates of several layers of material. For example, either or both may have on its inner side, defining the interlayer space, a taffeta or mesh lining to provide a smooth surface. Both the main layers will have some insulative capacity. The outer layer 14a is waterproof; the inner layer against the horse preferably is waterproof as well.

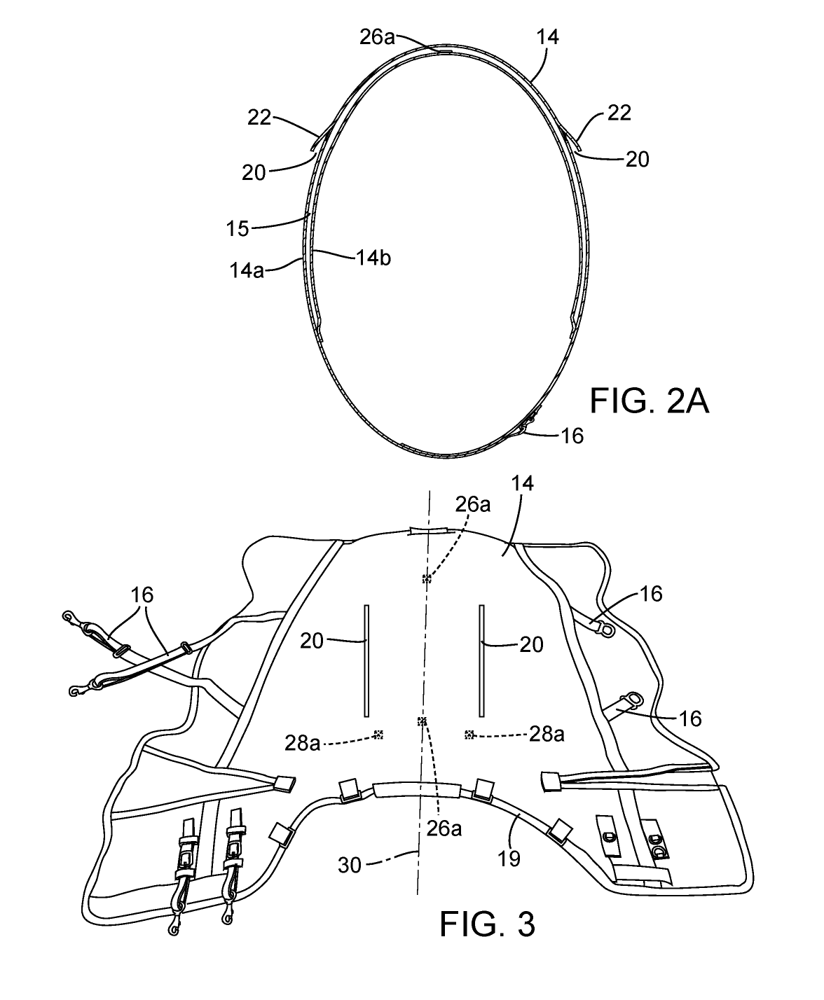

In FIG. 2 the blanket shell 14 is shown in cross section generally as worn on a horse. FIG. 3 shows a developed view of the blanket shell.

FIGS. 2 and 3 show a slit opening 20 formed horizontally, i.e. lengthwise relative to the horse, at an upper position on at least one side of the horse, and preferably on both. The length of the slit can be about 2 to 5 feet (or longer for a very large horse, e.g. 6 feet), preferably extending from behind the horse's front shoulder approximately back to the cavity below the ribs and above the hip. It is of sufficient length to allow insertion of a folded, rolled or bunched insulator insert, as discussed below. In a preferred form of the invention two such openable slits 20 are included, one on each side as shown in FIG. 3. The slit opening 20 is closeable in a substantially waterproof way, providing a substantial water barrier when closed. As an example, the opening 20 can have a flap at its upper side (e.g. about ½″ to 1½″ wide), so as to lie over the slit except when manually lifted. Beneath the flap can be VELCRO strips to hold the flap back in closed position, protecting the zipper or other hardware. The zipper is covered by the flap when not being operated. FIG. 2A, in a simple schematic cross section, shows such a flap 22 over the slit opening 20 at both sides. FIG. 2A also indicates the blanket shell 14 as including the outer layer 14a and inner layer or proximate layer 14b. The interlayer space 15 is seen between them.

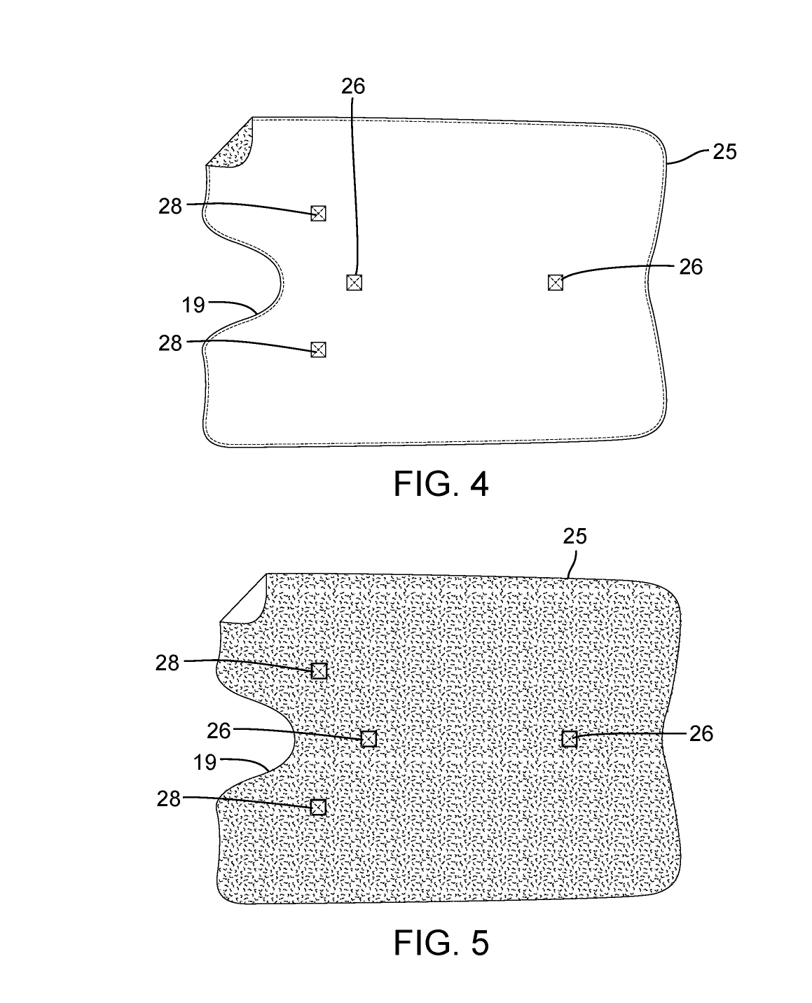

FIGS. 4 and 5 show, in unfolded or developed configuration, an insulator insert 25 of the horse blanket 12. The insert 25 may be of highly insulative materials such as in a typical sleeping bag, encapsulated within layers of fabric. Such insulative materials can be down, foam or typical polyfill material, such as PRIMALOFT. A series of insulator inserts 25 at different levels of insulation can be provided, selectable as to how much additional protection is needed for the horse. Also, or alternatively, insulators 25 can be stacked as needed. As seen in FIGS. 4 and 5, which show top and bottom sides of the insulator, respectively, the insert is shaped and sized to fit within the interlayer space of the blanket shell 14, between the outer and inner primary layers. The insert is folded, rolled or bunched and inserted through the open slit 20 into the interlayer space 15. Within that space the insulator 25 can be manually spread open and manipulated to fill or generally fill the space with the insulator unfolded and fully opened. The provision of the slit opening 20 on each of left and right sides of the blanket is preferred so that one can gain access to the blanket from both sides, to make easier the spreading out and distributing of the insulator within the interlayer space. It is preferable that the insulator insert 25 have a size and area such as almost to completely fill the interlayer space 15.

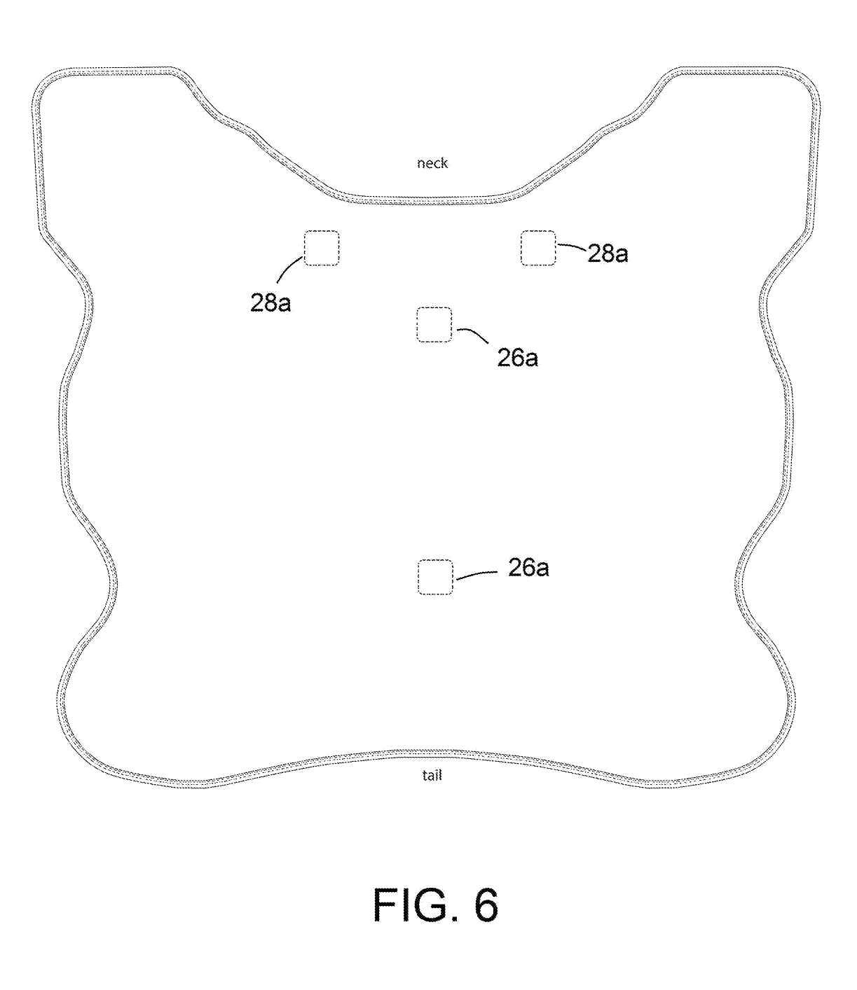

To retain the insulator 25 in position, VELCRO patches 26 can be included on one or both of the top and bottom sides of the insulator, preferably at center as shown. Additional hook or loop VELCRO patches 28 can be included at opposed left and right positions near the front (neck) end of the insulator. As shown in FIG. 6, and also FIG. 3, mating VELCRO patches 26a, 28a (shown in dashed lines, as hidden) can be positioned in the interlayer space, preferably on the upper sides of the inner layer 14b facing upwardly, or, alternatively, on the lower surface of the outer layer 14a facing downwardly. These can be somewhat larger strips, if desired, to provide a small range of positioning. The central VELCRO patches 26, 26a are approximately along the spine of the horse.

In preferred embodiments the slit openings 20 are positioned essentially parallel to and spaced from a longitudinal center line 30 (FIG. 3) of the horse blanket shell. The distance of each slit opening from the center line preferably is about 8 to 12 inches, or more preferably about 8 to 10 inches. If desired the slit could be farther from the center line, although the distances noted above are preferred for reasons of convenience and efficiency in installing insulative inserts, as explained below. In preferred embodiments two opposed slit openings 20 are included, and zippers are preferred as the closure, although VELCRO or other closure hardware could be used if desired.

The procedure for installing an insulator blanket is to stand at one side of the horse, for example the left side, and open the zipper. The attendant then inserts an insulator 25, bunched or folded, into the left-side opening and spreads the insulator and manipulates it into such a position that the VELCRO patches on the insulator insert engage with the VELCRO patches within the interlayer space, i.e. those positioned to mate with VELCRO patches 26a and 28a shown in FIG. 6. As noted above, four VELCRO patches may be included in the shell, with four mating VELCRO patches on the insert. Once the insulator has been properly positioned with the VELCRO patches engaged, manipulation and spreading of the insert is completed. The left side of the insert is pulled down and fully distributed in the space below the zipper opening. Then, the attendant moves over to the right side of the horse, opens the zipper on that side, and unfolds or un-gathers the remainder of the insert, distributing and positioning it so as to lie between the layers, above and below the right-side zipper opening.

If the horse requires further protection, an attendant can remove the existing insert and place a different insert of higher insulative value into the opening, using the procedure described above. Alternatively, as noted above, the attendant could place another insulator insert into the blanket shell, stacking it over the insulator already in place. This is the purpose of the VELCRO patches 26 shown in FIG. 4. These patches on the upper surface of the insulator are of the same type as the patches 26a, 28a on the upper side of the inner or proximate blanket shell layer 14b. For example, the patches 26a, 28a on the proximate shell 14b can be hook VELCRO. Similarly, the top of each insulator 25 will have hook VELCRO. In this way, any further insulative inserts added into the blanket shell will engage the bottom-side loop VELCRO with the hook VELCRO on the upper side of the insulator immediately below.

The above described preferred embodiments are intended to illustrate the principles of the invention, but not to limit its scope. Other embodiments and variations to these preferred embodiments will be apparent to those skilled in the art and may be made without departing from the spirit and scope of the invention, as defined in the following claims.

I claim:

1. A horse blanket, comprising:
a blanket shell having two layers through most of the expanse of the blanket shell, including an outer layer and a proximate layer underneath the outer layer, defining an interlayer space between the layers,
an elongated slit opening in the outer layer, extending lengthwise relative to a horse when worn and providing access to the interlayer space between the outer and proximate layers of the blanket shell, the slit opening being on a side of the blanket shell so as to be accessible from one side of a horse when worn,
a closure for the slit opening, the closure providing a selectively openable water barrier substantially preventing water from entering the interlayer space through the slit opening, and
an insulator insert of a size to fit into the interlayer space by insertion through the slit opening, to extend over a large area of the interlayer space so that the horse blanket acts as a heavier, more insulative blanket when needed.

2. The horse blanket of claim 1, wherein the blanket shell includes two said elongated slit openings, one on each side of the horse when worn.

3. The horse blanket of claim 1, wherein the elongated slit opening has a length in the range of about two to five feet.

4. The horse blanket of claim 1, including a plurality of such blanket inserts, each of different insulative value.

5. The horse blanket of claim 1, wherein the elongated slit opening has a length in the range of about two to six feet.

6. The horse blanket of claim 1, wherein the blanket shell has a longitudinal center line positioned to lie generally along a horse's spine when worn, and wherein the slit opening is parallel to the longitudinal center line and spaced away from the center line by at least about eight inches.

7. The horse blanket of claim 6, wherein the slit opening is about eight to twelve inches from the longitudinal center line.

8. The horse blanket of claim 6, wherein a second slit opening is provided, on an opposite side of the center line.

9. The horse blanket of claim 1, wherein the outer layer is of a waterproof, breathable material.

10. The horse blanket of claim 1, wherein the closure is a zipper, and the outer layer including a movable flap that normally covers the zipper.

11. The horse blanket of claim 1, wherein the blanket shell has hook or loop fastener patches in the interlayer space on one of the layers, and wherein the insulator insert has mating hook or loop fastener patches on a surface of the insert for correctly locating the insulator insert within the interlayer space.

12. The horse blanket of claim 11, wherein multiple said insulator inserts are provided, each having hook or loop fastener patches on each of upper and lower surfaces of the insulator insert, so that insulator inserts can be stacked within the interlayer space and correctly positioned using the hook and loop fastener patches.
